(19) United States
(12) Patent Application Publication
(10) Pub. No.: US 2008/0195373 A1
(43) Pub. Date: Aug. 14, 2008

(54) Digital Sign Language Translator

(76) Inventors: Barbara Ander, Fort Worth, TX (US); Sidney Ander, Fort Worth, TX (US)

Correspondence Address: LAW OFFICES OF JAMES E. WALTON, PLLC, 1169 N. BURLESON BLVD., SUITE 107-328, BURLESON, TX, 76028, US

(21) Appl. No.: 12/030,805

(22) Filed: Feb. 13, 2008

Related U.S. Application Data
(60) Provisional application No. 60/901,004, filed on Feb. 13, 2007.

(51) Int. Cl. G06F 17/28

(52) U.S. Cl. 704/2

(57) ABSTRACT

A digital sign language translator system has a means for inputting words and phrases, a microprocessor for digitally translating the words and phrases into sign language, and a means for displaying the corresponding sign language.

This application claims the benefit of U.S. Provisional Application No. 60/901,004, filed 13 Feb. 2007, titled, “Sign Language Pocket Translator.”

### BACKGROUND

1. Field of the Invention

The present invention relates to digital dictionaries and digital foreign language translators.

2. Description of Related Art

Digital dictionaries and digital foreign language translators have been around for many years. Many of these devices allow a user to input a word or phrase in English, and then the device displays the meaning of the word or its foreign language equivalent on a display screen.

Although great strides have been made in the area of digital dictionaries and digital foreign language translators, considerable shortcomings remain.

### DESCRIPTION OF THE DRAWINGS

The novel features believed characteristic of the invention are set forth in the description. However, the invention itself, as well as, a preferred mode of use, and further objectives and advantages thereof, will best be understood by reference to the following detailed description when read in conjunction with the accompanying drawings, wherein:

FIG. 1 is a perspective view of the preferred embodiment of a digital sign language translator according to the present application; and

FIG. 2 is a high-level block diagram of the digital sign language translator system of the present application;

FIG. 3 is a flowchart of the dictionary feature of the digital sign language translator system of the present application; and

FIG. 4 is a flowchart of the video interpreter feature of the digital sign language translator system of the present application.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as described herein.

### DETAILED DESCRIPTION OF THE PREFERRED EMBODIMENT

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

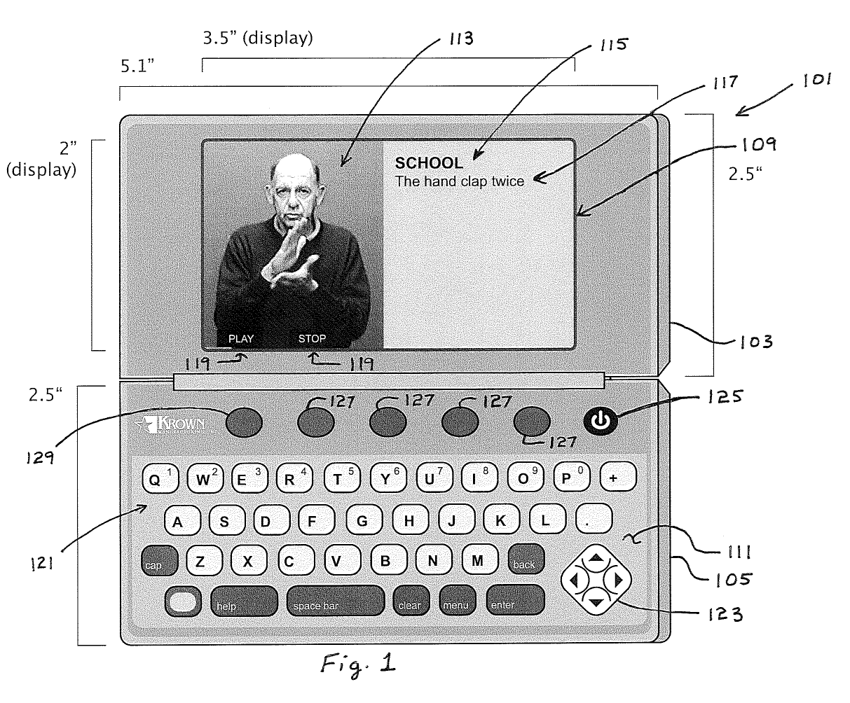

Referring to FIG. 1 in the drawings, the preferred embodiment of a digital sign language translator 101 according to the present application is illustrated. In the preferred embodiment, translator 101 is configured as a small hand-held electronic device, similar in size and shape to personal digital assistants (PDA's), cell phones, or personal organizer. In the example of FIG. 1, translator 101 has been shown as a small, clamshell-type, hand-held device having a top portion 103 and a bottom portion 105, in which top portion 103 is hingedly coupled to bottom portion 105 to form a hinged case 107. It will be appreciated that translator 101 may take on a wide variety of configurations. For example, instead of a clamshell configuration, top portion 103 may slide or translate relative to bottom portion 105, or top portion 103 may pivot or twist relative to bottom portion 105, or top portion 103 may move in a combination of translations and rotations relative to bottom portion 105.

Translator 101 includes one or more data input devices, one or more output devices, one or digital memory devices, and at least one microprocessor for controlling and performing the various features and functions of translator 101. Translator 101 is an electronic device powered by one or more electronic poser sources. In the preferred embodiment, translator 101 is powered by one or more DC batteries. In one embodiment, translator 101 is powered by rechargeable batteries that are recharged by connecting translator to another power source, such as a transformer that is plugged into an AC power outlet, a docking station or cradle via a terminal-to-terminal connection, a personal computer via a universal serial bus (USB) or other type of connection, or any other type of recharging means. Translator 101 may include a wide variety of input, output, and data transfer devices and ports. For example, translator 101 may include one or more USB ports, one or more external digital memory card slots, disc drives, one or more control switches or buttons, infrared (IR) data transfer ports, wireless communication antennas, microphones, speakers, cameras, and selected integrated circuits and chip sets.

In the example of FIG. 1, a digital video display 109 is carried by top portion 103 and a keypad portion 111 is carried by bottom portion 105. In the preferred embodiment, display 109 is divided into one or more display areas. For example, display 109 includes a “video” area 113, a “dictionary” area 115, a “description” area 117, and a “function” area 119. Video area 113 is used to display videos of people carrying out the hand, finger, and body motions of selected words and phrases in sign language. Dictionary area 115 is used to display the words or phrases that the user has input. Description area 117 is used to display textual or graphic instructions of how to carry out the finger hand, and body motions of selected words and phrases in sign language. Function area 119 is used to identify selected keys or key combinations that when pressed cause translator to carry out certain preprogrammed or programmable instructions. It should be understood that display 109 may have many other “areas” and functions, depending upon the application in use and the mode of operation in which translator 101 is operating. Furthermore, it will be appreciated that display 109 may also be a touch screen type display. As such, display 109 may serve as both an input means and an output means.

Keypad portion 111 may be divided into selected areas. For example, keypad portion 111 may include a QWERTY type keyboard 121, or may include a smaller number of keys that are capable of performing, such as by software, entry of alpha-numeric data. Keypad 111 may include one or more directional keys, such as directional button 123, and may include one or more joysticks, touch pads, or mouse pads. A power button or switch 125 is included for switching translator 101 between an on mode and an off mode. One or more programmable function keys 127 may also be included on keypad 111. Programmable function keys may be preprogrammed or user programmable. For example, a function key 129 may be aligned with a particular option in the function area of display 109, such that when the user presses function key 129, translator 101 performs the function indicated in the corresponding function area. As shown in FIG. 1, if the user were to press function key 129, translator 101 would “PLAY” the video. Programmable function keys 127 may also be programmed for use with commonly used words or phrases.

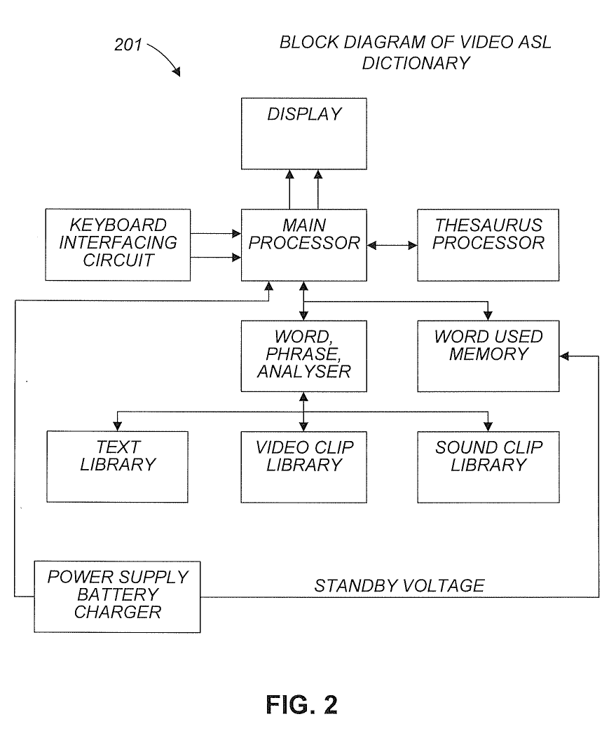

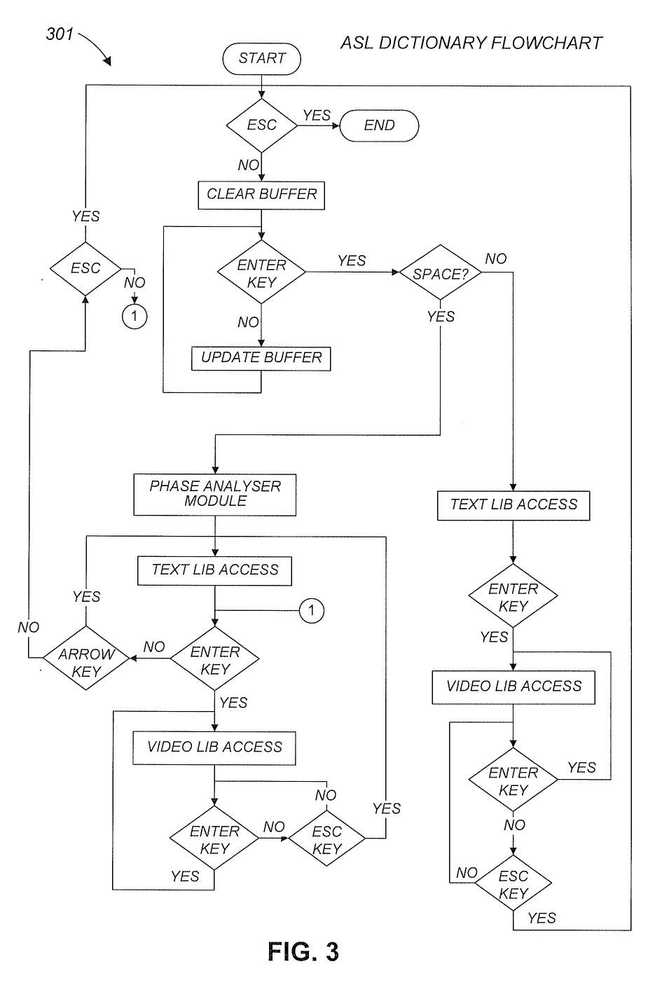

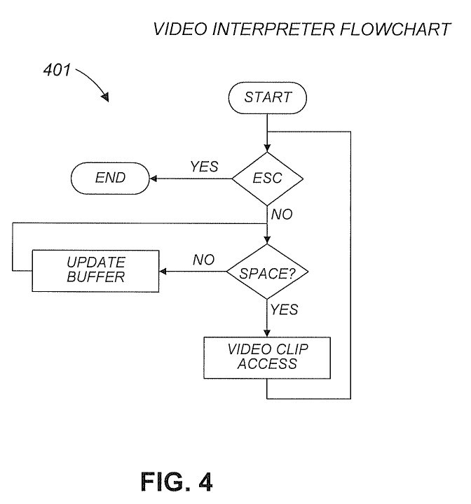

Referring now also to FIGS. 2-4 in the drawings, a portion of the functionality of translator 101 is illustrated. FIG. 2 shows a high-level block diagram 201 of translator 101, FIG. 3 shows a flowchart 301 of the dictionary feature of translator 101, and FIG. 4 shows a flowchart 401 of the video interpreter feature of translator.

In the preferred embodiment, the microprocessor and the memory devices store one or more databases, including a dictionary database of words and phrases and a database of videos of finger, hand, and body motions that represent certain sign language letters, words, and phrases. Software stored in the microprocessor and/or the memory devices receives input data from the user and causes the appropriate video, graphics, and/or text to be displayed on display 109. For example, if the user enters the letter “S,” then a list of words or phrases beginning with the letter “S” is displayed in one of the areas of display 109. Then, the user can either choose one of the words from the list or enter additional letters. Once the user chooses a word from the list, such as “SCHOOL,” the corresponding video of the sign language interpretation of the word “SCHOOL” is displayed and played in video area 113 of display 109. Also, the word “SCHOOL” would be displayed in dictionary area 115 and the instruction “The hands clap twice,” would be displayed in description area 117 of display 109. The user may use certain function keys 127 and 129 to manipulate the playing and repeating of the video.

It will be appreciated that translator 101 may be programmed to operate in many different modes, including a “word” mode, which is described above, a “phrase” mode, in which phrases are entered and/or displayed. Other modes of operation include a synonym mode, in which synonyms are displayed; a homonym mode, in which homonyms are displayed; a thesaurus mode, in which words with similar meanings are displayed; mistyped word mode, in which digital logic techniques may be utilized to predict what the user meant; and a slang mode, in which slang words and phrases are included. Translator 101 may be designed and programmed to operate at various user levels, such as skill levels and learning levels. In addition, translator 101 may be programmed to include, or may be upgradeable to include certain words and phrases that may be specific to different businesses and industries, such as medical, legal, and engineering, and may include multiple sign language translations for a single word or phrase, such as different dialects or base languages. External memory cards are particularly well suited for carrying out such modifications and upgrades to translator 101.

Translator 101 may be updated and upgraded via wired communication links, wireless communication links, memory cards, disc drives, and by synchronization with computers or computer networks. In addition, it will be appreciated that translator 101 may include a wide variety of other features and components that may or may not be directly related to sign language translation, such as date books, calendars, clocks, address books, calculators, word processors, cell phones, PDA's, pagers, vibrating devices and alarms,

The invention of the present application may also be carried out and practiced as a digital sign language translator system. In the “system” embodiment, the user may access the system remotely via a wired or wireless communication network or system, such as the Internet. For example, the user might log on to a designated Internet Webpage and perform certain features and functions. The user could enter words and phrases into fields on the Webpage, and the system could display the corresponding videos and other information related to the user's requests. In another embodiment of the system, the translator may be entirely carried out by software that is installed and run on a computing device, such as a computer, cell phone, PDA, or other computing device.

In addition, the system may also be implemented via a kiosk system in which kiosks are located and accessed at selected locations, such as schools, universities, airports, hospitals, retail outlets, or any other public place. The kiosk system could consist of one or more stand-alone devices, or the individual kiosks could be networked together and controlled and maintained by a central server.

In another embodiment, translator 101 may be configured as a “pay-as-you-go” system, in which all available features and functions may reside on translator 101, but the user must pay a selected amount of money to have each of the features and functions activated.

The invention of the present application has a wide variety of modes of operation, including: (1) a “translate” mode, in which a user inputs a word or phase and translator 101 displays a video of the corresponding sign language; (2) a “learn” mode, in which a user interactively practices her sign language skills; (3) a “test” mode, in which the user takes tests to confirm his skills; (4) an “administration” mode, in which other functions and features are used, including upgrading and maintaining the databases; as well as many other possible modes of operation.

It is apparent that an invention with significant advantages has been described and illustrated, including (1) a small hand-held device that can quickly, easily, and accurately translate from text to sign language; (2) a sign language translation system that can be accessed by many users simultaneously over a computer network; and (3) a kiosk system that can be distributed over many different locations to provide sign language translations.

The particular embodiments disclosed above are illustrative only, as the invention may be modified and practiced in different but equivalent manners apparent to those skilled in the art having the benefit of the teachings herein. The particular embodiments disclosed herein may be altered or modified, and all such variations are considered within the scope and spirit of the invention. Although the present invention is shown in a limited number of forms, it is not limited to just these forms, but is amenable to various changes and modifications without departing from the spirit thereof.

We claim:

1. A digital sign language translator, comprising:
a means for inputting words and phrases;
a microprocessor for digitally translating the words and phrases into sign language; and
a means for displaying the corresponding sign language.
